(19) United States
(12) Patent Application Publication
(10) Pub. No.: US 2022/0066564 A1
(43) Pub. Date: Mar. 3, 2022

(54) Managing Touch Inputs based on Device Movement

(71) Applicant: Motorola Mobility LLC, Chicago, IL (US)

(72) Inventors: Amit Kumar Agrawal, Bangalore (IN); Olivier David Meirhaeghe, Lincolnshire, IL (US); Fred Allison Bower, III, Durham, NC (US)

(73) Assignee: Motorola Mobility LLC, Chicago, IL (US)

(21) Appl. No.: 17/002,027

(22) Filed: Aug. 25, 2020

(51) Int. Cl. G06F 3/01; G06F 3/0482; G06F 3/0488; G06F 3/041; G06F 1/16

(52) U.S. Cl. CPC G06F 3/017; G06F 3/0482; G06F 1/1643; G06F 3/04186; G06F 3/04883

(57) ABSTRACT

In aspects of managing touch inputs based on device movement, a wireless device has a display screen to display a user interface that includes selectable elements, which are selectable to initiate respective device application actions. The wireless device implements an input control module that can determine the wireless device is in a stationary position based on sensor inputs. The input control module can receive a touch input on a selectable element of the user interface, and detect whether the wireless device has been moved from the stationary position substantially incident to the touch input being received. The input control module can then disregard the touch input if the wireless device has been moved from the stationary position substantially incident to the touch input being received, or initiate processing the touch input if the wireless device has not moved from the stationary position substantially incident to the touch input being received.

### BACKGROUND

Devices such as smart devices, mobile devices (e.g., cellular phones, tablet devices, smartphones), consumer electronics, and the like can be implemented with various display screen configurations. For example, a smartphone may be implemented with a display screen that is flat and encompasses most of one side of the device. More recently, some mobile devices are designed with a curved display screen that wraps around all or part of the vertical sides of a device. Generally, a curved display screen has a curved edge display on both vertical sides of a device, and the curved edge displays can be used to display user interface content and other display screen content.

While the curved edges of a curved display screen generally enhances the aesthetics of a device, the curved edges introduce various design and usability challenges, particularly for user interface selectable controls that may be displayed within the curved edge display. Generally, mobile devices may operate in different modes with various user interfaces that include selectable controls, some of which may be displayed within the curved edges of a device display. For example, a mobile device can operate for typical use in a high-power mode when turned on, and a home screen user interface includes selectable controls, such as to initiate device applications. A mobile device may also be operational with a lock screen from which some device features can be activated, such as quick activation of the device camera, emergency call functions, a flashlight, and other lock screen features, even though general use of the device is locked. Additionally, a mobile device may operate in a low-power mode with an always-on-display (AoD) in which the device processor is typically powered-down and the device display is implemented for low-power usage. The AoD mode may be used to detect movement or an approaching user, and operate the device in either a locked or unlocked state, such as depending on whether the user has initiated a lock screen security mechanism (e.g., enter a PIN, pattern, password, fingerprint sensor activation, etc.).

If a user grabs, picks-up, and/or moves a mobile device that is operating in any one of the different modes, the user may inadvertently contact and activate one of the user interface selectable controls or one of the lock screen features with some portion of his or her palm or fingers, particularly when picking up and holding the device by the sides. The inadvertent contact then registers as a user touch selection on an actionable element displayed on the device user interface, on the lock screen user interface, and/or on the AoD mode user interface of the device.

### BRIEF DESCRIPTION OF THE DRAWINGS

Implementations of the techniques for managing touch inputs based on device movement are described with reference to the following Figures. The same numbers may be used throughout to reference like features and components shown in the Figures:

FIG. 1 illustrates an example of techniques for managing touch inputs based on device movement using a wireless device in accordance with one or more implementations as described herein.

FIG. 2 illustrates examples of features for managing touch inputs based on device movement using a wireless device in accordance with one or more implementations as described herein.

FIG. 3 illustrates an example method of managing touch inputs based on device movement in accordance with one or more implementations of the techniques described herein.

FIG. 4 illustrates another example method of managing touch inputs based on device movement in accordance with one or more implementations of the techniques described herein.

FIG. 5 illustrates various components of an example device that can be used to implement the techniques for managing touch inputs based on device movement as described herein.

### DETAILED DESCRIPTION

Implementations of managing touch inputs based on device movement are described, and provide techniques that can be implemented by a wireless device, particularly for devices that display various user interfaces in different device modes, and inadvertent touch contacts on selectable elements in an application user interface or on a lock screen user interface can occur when a user grabs or picks-up and moves the device. A wireless device can include many different types of device applications, many of which generate or have a user interface that displays on the display screen of the device, as well as a lock screen user interface that typically turns-on and displays when a device is moved or picked-up for use. An application user interface or lock screen user interface typically includes selectable elements displayed in the user interface, and a selectable element can be selected by a user of the device with a touch input to initiate a corresponding device application action. A mobile device may also be implemented to operate in in a low-power mode with an always-on-display (AoD) in which the device processor is typically powered-down and the device display is implemented for low-power usage. The AoD mode may be used to detect movement or an approaching user, and operate the device in either a locked or unlocked state, such as depending on whether the user has initiated a lock screen security mechanism.

Notably, a touch contact on selectable element in a user interface can occur when a user grabs or picks-up and moves a device, where the touch contact may be either an intended touch input on the selectable element, or an inadvertent touch contact that is registered as a touch input, yet the user of the device did not intend to initiate the corresponding device application action. Accordingly, the techniques for managing touch inputs based on device movement can be implemented to allow, or not allow, a touch input on a selectable element in the user interface on the device display screen based on detected device movements, and this is generally applicable to both flat display screens and display screens with curved display edges. This effectively limits device application actions from being initiated based on inadvertent touch contacts on the selectable elements that may be displayed in the various user interfaces in the different device modes.

In aspects of managing touch inputs based on device movement, the wireless device has a display screen, which may be a flat display screen, or a display screen that is a curved display, which wraps around all or part of the vertical sides of the wireless device. The display screen can display a user interface, such as a device application user interface, a lock screen user interface, and/or an AoD mode user interface of the device that includes selectable elements, which are selectable to initiate respective device application actions. The wireless device implements an input control module that can determine the wireless device is in a stationary position based on sensor inputs. The input control module can receive a touch input on a selectable element of the user interface, and can also detect whether the wireless device has been moved from the stationary position substantially incident to the touch input being received. The input control module can then disregard the touch input if the wireless device has been moved from the stationary position substantially incident to the touch input being received, or initiate processing the touch input if the wireless device has not moved from the stationary position substantially incident to the touch input being received.

While features and concepts of managing touch inputs based on device movement can be implemented in any number of different devices, systems, environments, and/or configurations, implementations of managing touch inputs based on device movement are described in the context of the following example devices, systems, and methods.

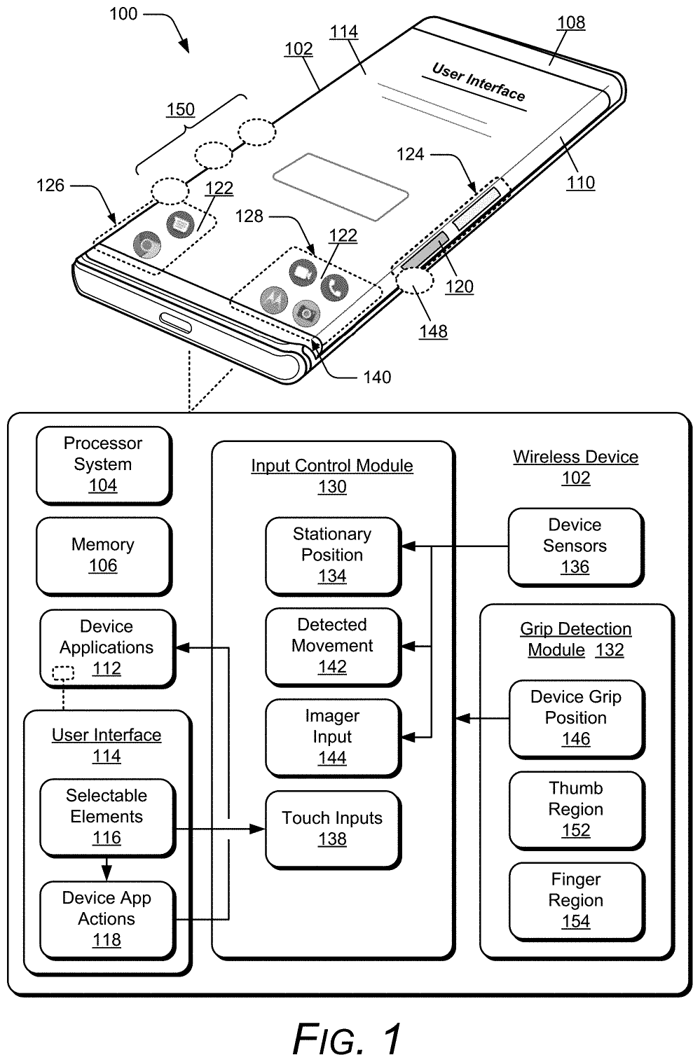

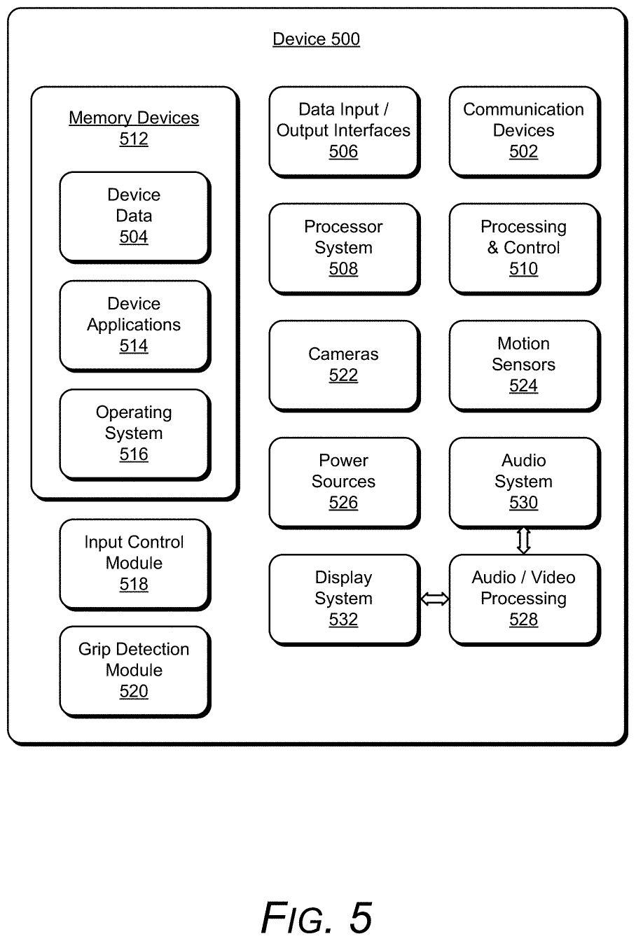

FIG. 1 illustrates an example 100 of techniques for managing touch inputs based on device movement, such as implemented with a wireless device 102. In this example 100, the wireless device 102 may be any type of a mobile phone, flip phone, computing device, tablet device, and/or any other type of mobile device. Generally, the wireless device 102 may be any type of an electronic, computing, and/or communication device implemented with various components, such as a processor system 104 and memory 106, as well as any number and combination of different components as further described with reference to the example device shown in FIG. 5. For example, the wireless device 102 can include a power source to power the device, such as a rechargeable battery and/or any other type of active or passive power source that may be implemented in an electronic, computing, and/or communication device.

The wireless device 102 includes a display screen 108, which in this example 100, is a curved display that wraps around, or partially wraps, the vertical sides of the wireless device. Generally, the display screen 108 has the curved display edges 110 on both vertical sides of the wireless device, and the curved display edges can be utilized to display any type of user interface or other display screen content. It should be noted that the techniques described herein for managing touch inputs based on device movement are also applicable for a wireless device that has a traditional, flat display screen. The wireless device 102 also includes device applications 112, such as a text application, email application, video service application, cellular communication application, music application, and/or any other of the many possible types of device applications. Many device applications 112 have an associated user interface that is generated and displayed for user interaction and viewing. Similarly, a lock screen user interface may be displayed on the display screen 108 of the wireless device. In this example 100, the display screen 108 of the wireless device 102 can display a user interface 114 that is associated with a device application 112, or as a lock screen user interface.

The user interface 114 of a lock screen or device application 112 may include one or more selectable elements 116, which are user selectable, such as with a touch input, press, hold, or tap to initiate corresponding device application actions 118. For example, the user interface 114 displayed on the display screen 108 may be associated with a music playback application (e.g., any type of a device application 112), and the user interface includes selectable elements 116, such as selectable elements 120 that a user can select with a touch input to change the song that is currently playing, or other selectable elements that the user can select to initiate some other device application action. Similarly, the user interface includes other various selectable elements 122 that a user can select with a touch input to initiate respective device application actions, such as to initiate the device camera, make a call, start a meeting, and the like. In this example 100, the selectable elements 120 of the user interface 114 are displayed in a region 124 of a curved display edge 110 of the display screen 108. The other selectable elements 122 of the user interface 114 are displayed in regions 126, 128 on the display screen.

In this example 100, the wireless device 102 implements an input control module 130 and a grip detection module 132, which can be implemented as separate modules that may include independent processing, memory, and/or logic components functioning as a computing and/or electronic device integrated with the wireless device 102. Alternatively or in addition, either of the modules can be implemented in software, in hardware, or as a combination of software and hardware components. In this example, the input control module 130 and the grip detection module 132 are implemented as software applications or modules, such as executable software instructions (e.g., computer-executable instructions) that are executable with a processor (e.g., with the processor system 104) of the wireless device 102 to implement the techniques and features of managing touch inputs based on device movement, as described herein.

As software applications or modules, the input control module 130 and the grip detection module 132 can be stored on computer-readable storage memory (e.g., the memory 106 of the device), or in any other suitable memory device or electronic data storage implemented with the modules. Alternatively or in addition, the input control module 130 and/or the grip detection module 132 may be implemented in firmware and/or at least partially in computer hardware. For example, at least part of the modules may be executable by a computer processor, and/or at least part of the modules may be implemented in logic circuitry.

In implementations, the input control module 130 is implemented by the wireless device 102 to limit device application actions 118 from being initiated based on inadvertent touch inputs on the selectable elements 116 that are displayed in the user interface on the display screen 108 and in the curved display edges 110 of the display screen, in conjunction with detected movement of the device. In particular, the input control module 130 is implemented to prevent device application actions 112 from being initiated based on inadvertent touch inputs on the selectable elements, such as when a user of the wireless device grabs or picks-up and moves the device, and an inadvertent touch contact is registered as a touch input that unintentionally initiates the corresponding device application action.

The input control module 130 can determine that the wireless device 102 is in a stationary position 134 based on sensor inputs from device sensors 136. For example, the device sensors 136 of the wireless device may include any one or combination of motion sensors, an accelerometer, a gyroscope, and/or any other type of sensors, such as may be implemented in an inertial measurement unit. The device sensors 136 can generate sensor data that indicates location, position, acceleration, rotational speed, and/or orientation of the device, and the input control module 130 can determine that the wireless device is in a stationary position 134, such as when set on a flat surface and/or not being handled by a user of the device.

The input control module 130 can determine, or receive notification, that the user interface 114 corresponds to an active lock screen or a foreground active device application 112, which causes the selectable elements 116 of the user interface 114 to be active. The input control module 130 can receive a touch input 138 on a selectable element 116 of the user interface 114, which may be an inadvertent touch contact on the selectable element, rather than an intended user input that is received on the user interface 114 as a press, hold, tap, touch, or similar type input. In implementations, the touch inputs 138 are registered with the input control module 130. However, an inadvertent touch selection of a selectable element 116 is also registered as a touch input 138, but the user of the wireless device 102 may not have intended to initiate the corresponding device application action 118. As noted above, these inadvertent touch selections or inputs can occur when a user of the wireless device 102 grabs or picks-up and moves the device, and an inadvertent touch contact is registered as a touch input, causing the corresponding device application action 118 to be initiated or activated. These inadvertent touch contacts or inputs are generally detectable because, when an unintended device application action 118 is initiated, the user of the device does not utilize the invoked action, or quickly reverses course to undo or dismiss the invoked action.

The input control module 130 can receive a touch input 138 (or an inadvertent touch contact) on a selectable element 120 of the user interface 114 within the region 124 of a curved display edge 110 of the display screen 108. Similarly, the input control module 130 can receive a touch input 138 (or an inadvertent touch contact) on any of the various selectable elements 122 of the user interface 114 within the regions 126, 128 of the display screen. As is common when a user of the wireless device 102 grabs or picks-up and moves the device, the input control module 130 may receive an inadvertent touch contact as a touch input 138 on a selectable element 122 of the user interface 114 within a corner region 140 of the display screen. These inadvertent activations may be caused by the hand, fingers, or palm coverage from a user of the device, such as when the device is moved as the user grabs the device to pick it up for use.

Generally, as described with reference to the example device shown in FIG. 5, the wireless device 102 has an operating system with a system layer (e.g., kernel layer) that can receive indications of touch input events on the user interface 114 at the device layer when a user of the wireless device attempts to activate a device application action 118 by selecting a corresponding selectable element 116. The input control module 130 can register as an application, at the application layer, with the system layer to receive indications, notifications, and/or communications as to the selectable elements 116 that are displayed in a user interface 114. The input control module 130 can also manage the touch inputs 138 based on detected movement 142 of the device.

As noted above, the input control module 130 can receive a touch input 138 (or an inadvertent touch contact) on a selectable element 120 of the user interface 114, and detect whether the wireless device 102 has been moved from the stationary position 134 substantially incident to the touch input 138 being received. For example, a touch input 138 may be received as an inadvertent touch contact when the device is moved by the user, and the input control module 130 can detect that the movement 142 of the device occurs simultaneously, or approximately simultaneously, with the occurrence of the touch input 138 being received. For example, the input control module 130 can associate a touch input 138 within the corner region 140 of the display screen 108 with the likelihood of the wireless device 102 being handled by the user, and the touch input 138 is therefore likely an inadvertent touch contact on a selectable element 122 in the display region 128.

Notably, the input control module 130 can delay processing of a touch input 138 on the selectable element 116 of the user interface 114 to determine whether the wireless device 102 has been moved from the stationary position 134 substantially incident, or in conjunction with, the touch input being received. For example, a touch input 138 on a selectable element 116 of the user interface 114 can be buffered for a short duration of time (e.g., 500 milliseconds) to allow for movement detection of the device before the touch input is processed for activation of the corresponding device application action 118.

In implementations, the input control module 130 can receive accelerometer or gyroscopic inputs from the device sensors 136 indicating movement of the wireless device 102, such as from the stationary position 134 to a handheld position. The input control module 130 can then detect or determine device movement 142 from the stationary position 134 substantially incident to the touch input 138 being received based on the accelerometer and/or gyroscopic inputs received from the device sensors. Alternatively or in addition, the input control module 130 can receive an imager input 144 from an imaging sensor (e.g., a device sensor 136), and the imager input 144 includes an image of a user approaching the wireless device.

The imaging sensor may be the device camera or other type of low-power glance sensor that can detect or activate on a face of the user, or hands detected approaching the device. Notably, the detected approaching user does not need to be authenticated as the imager input 144 is used by the input control module 130 to detect or determine movement of the device from the stationary position 134. The input control module 130 can associate the imager input 144 with the detected movement 142 of the wireless device 102 from the stationary position 134 substantially incident to the touch input 138 being received. The input control module 130 can then determine a likelihood of the wireless device 102 being handled by the user and the touch input 138 is therefore likely an inadvertent contact on a selectable element.

In aspects of the techniques for managing touch inputs based on device movement, as described herein, the input control module 130 can receive a touch input 138 (or an inadvertent touch contact) on a selectable element 120, 122 of the user interface 114, detect whether the wireless device 102 has been moved from the stationary position 134, and then either disregard the touch input or allow the touch input to process in the wireless device. For example, the input control module 130 can disregard the touch input 138 if the wireless device 102 is detected as having been moved from the stationary position 134 substantially incident to the touch input being received. Alternatively, the input control module 130 can allow or initiate processing the touch input 138 if the wireless device 102 is detected as not having been moved from the stationary position 134 substantially incident to the touch input being received.

In other implementations, the input control module 130 can receive a device grip position 146 of a user grip holding the wireless device 102 from the grip detection module 132. The input control module 130 can then determine that the device grip position 146 is proximate a display region 124 of the curved display edge 110, or proximate a display region 126, 128 on the display screen 108, in which selectable elements 120, 122 of the user interface 114 are displayed. The input control module 130 may then utilize the device grip position 146 to detect or determine whether a touch input 138 on a selectable element 120, 122 of the user interface 114 is an inadvertent touch contact, and/or to detect whether the wireless device 102 has been picked-up by the user and moved from the stationary position 134.

The grip detection module 132 is implemented by the wireless device 102 to detect the device grip position 146 of a user grip holding the wireless device. A representation of a user grip holding the device is generally shown as a thumb position 148 on one vertical side of the wireless device 102, and finger positions 150 on the other vertical side of the device, as if a user were holding the device with his or her right hand. Typically, a user grips and holds a device with his or her thumb on one side, and two or three fingers on the other side of the device, which also likely contacts or rests in some portion of the user's palm of his or her hand. The thumb position 148, the finger positions 150, and/or the user's palm of his or her hand also likely contact some areas of the curved display edges 110 of the display screen 108 and/or contact the display screen in the various regions that include the displayed selectable elements.

The grip detection module 132 can also determine which hand, left or right, the user is using to hold the wireless device 102, as well as the vertical position along the vertical sides of the device. For example, the user may grip and hold the device with his or her right hand, vertically more towards the lower section or bottom of the device, as shown in this example 100. Notably, the grip detection module 132 can determine a thumb region 152 of the device grip position 146 on a first side of the wireless device, such as proximate the thumb position 148. The grip detection module 132 can also determine a finger region 154 of the device grip position 146 on a second side of the wireless device, such as proximate the finger positions 150. In instances when a user changes hands and/or adjusts the grip position, the grip detection module 132 can detect a change in the device grip position 146 of the user grip holding the wireless device.

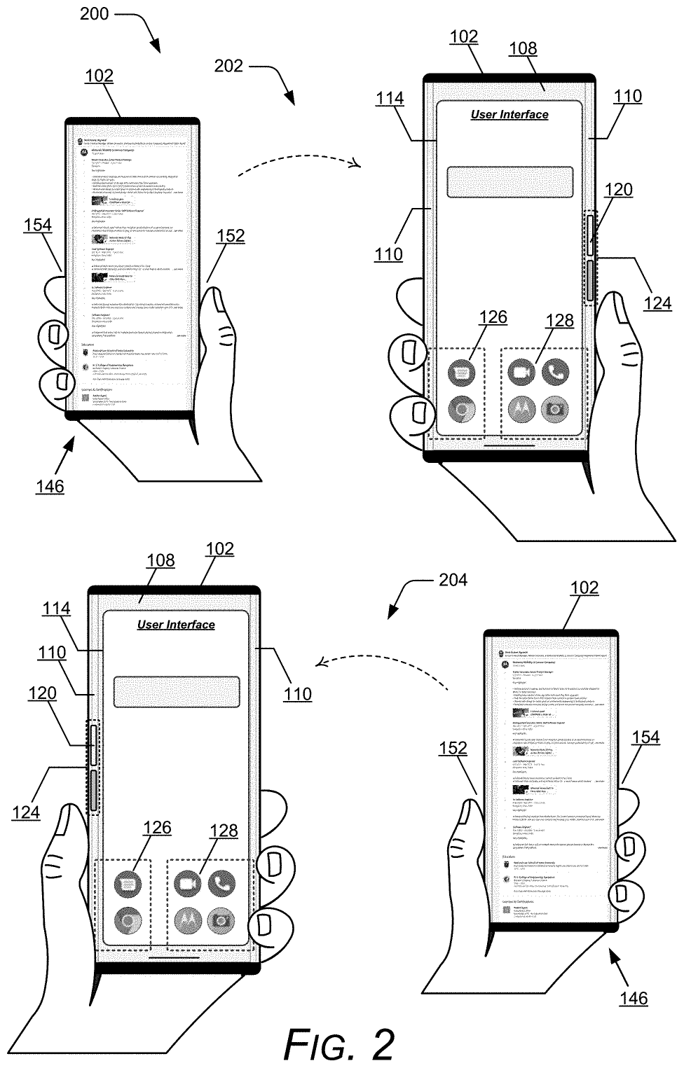

FIG. 2 illustrates examples 200 of aspects and features for managing touch inputs based on device movement, as described herein, such as using the wireless device 102 as shown and described with reference to FIG. 1. As shown in an example 202, a user of the wireless device 102 may hold the device in his or her right hand. The grip detection module 132 that is implemented by the wireless device 102 can detect the device grip position 146 of the user grip holding the wireless device. The grip detection module 132 can determine the thumb region 152 of the device grip position 146 on a first side of the wireless device, and also determine the finger region 154 of the device grip position 146 on a second side of the wireless device.

The display screen 108 of the wireless device 102 can display the user interface 114 that is associated with a device application 112, as well as the selectable elements 120, 122 of the user interface 114 that are associated with the device application actions 118. For example, the selectable elements 120 of the user interface 114 are displayed in the region 124 of the curved display edge 110 of the display screen 108 of the wireless device, and the selectable elements 122 are displayed in the regions 126, 128 of the display screen 108. The input control module 130 can determine that the device grip position 146 is proximate the display region 124 of the curved display edge 110 in which the selectable elements 120 of the user interface 114 are displayed, and determine that the finger positions 150 of the device grip position 146 are proximate the display region 126 on the display screen 108, as well as the thumb position 148 of the device grip position 146 is proximate the display region 128 on the display screen.

An example 204 illustrates an instance of the user changing hands to hold the wireless device 102 in his or her left hand, and the grip detection module 132 can detect the change in the device grip position 146 of the user grip holding the device. Additionally, the selectable elements 120 of the user interface 114 are displayed in the curved display edge 110 of the display screen 108 of the wireless device 102, and the selectable elements 122 are displayed in the regions 126, 128 of the display screen 108. Accordingly, the input control module 130 can determine that the device grip position 146 is proximate the display region 124 of the curved display edge 110 in which the selectable elements 120 of the user interface 114 are displayed, and determine that the finger positions 150 of the device grip position 146 are proximate the display region 128 on the display screen 108, as well as the thumb position 148 of the device grip position 146 is proximate the display region 126 on the display screen.

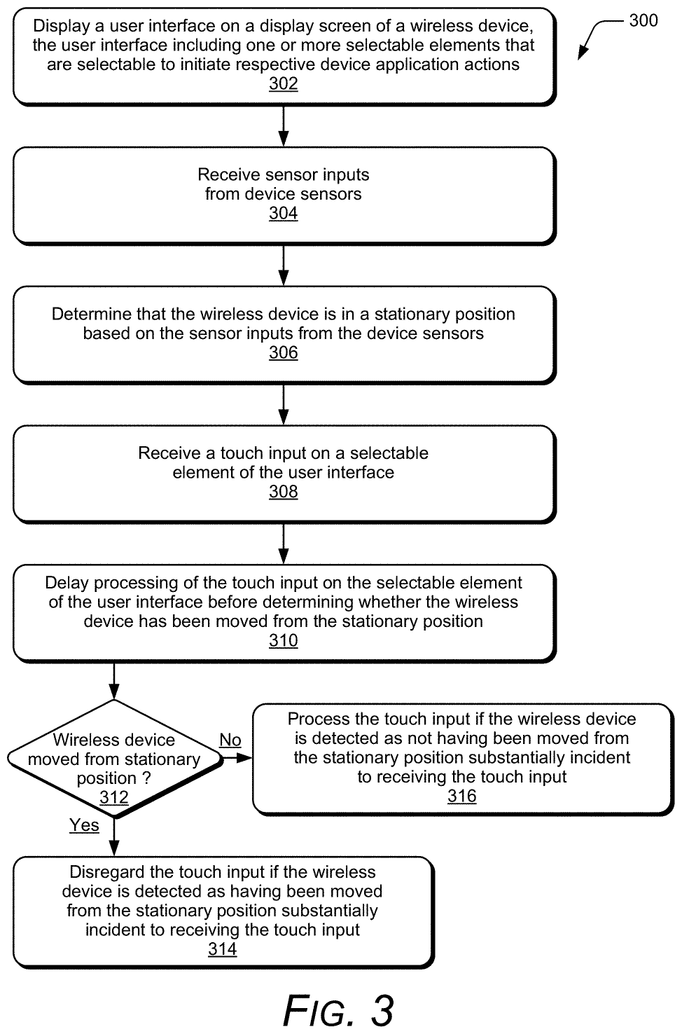

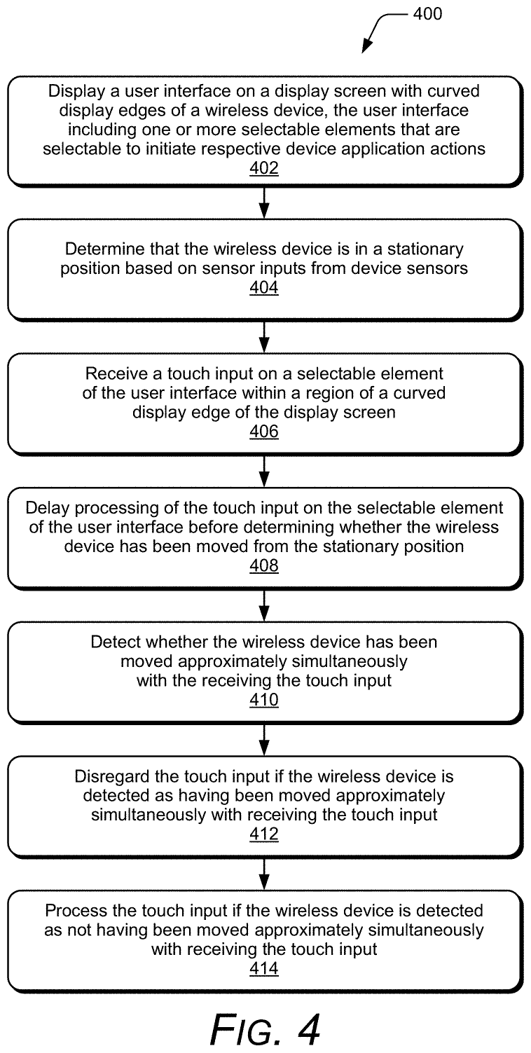

Example methods 300 and 400 are described with reference to respective FIGS. 3 and 4 in accordance with implementations of managing touch inputs based on device movement. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 3 illustrates example method(s) 300 of managing touch inputs based on device movement, and is generally described with reference to a wireless device, as well as an input control module implemented by the device. The order in which the method is described is not intended to be construed as a limitation, and any number or combination of the described method operations can be performed in any order to perform a method, or an alternate method.

At 302, a user interface is displayed on a display screen of a wireless device, the user interface including one or more selectable elements that are selectable to initiate respective device application actions. For example, the display screen 108 of the wireless device 102 displays the user interface 114 with selectable elements 116, such as the selectable elements 120, 122 that are user selectable to initiate corresponding device application actions 118 that are associated with respective device applications 112. In implementations, the wireless device 102 may include a flat display screen, or a display screen with curved display edges 110 on both vertical sides of the device to display a portion of the user interface. The curved display edges 110 of the display screen 108 can be utilized to display any type of user interface or other display screen content.

At 304, sensor inputs are received from device sensors. For example, the input control module 130 implemented by the wireless device 102 can receive sensor inputs from the device sensors 136, which may include any one or combination of motion sensors, an accelerometer, a gyroscope, and/or any other type of sensors, such as may be implemented in an inertial measurement unit. In implementations, the input control module 130 can receive accelerometer or gyroscopic inputs from the device sensors 136 indicating movement of the wireless device 102, such as from the stationary position 134 to a handheld position. Alternatively or in addition, the input control module 130 can receive an imager input 144 from an imaging sensor (e.g., a device sensor 136), and the imager input 144 includes an image of a user approaching the wireless device. The imaging sensor may be the device camera or other type of low-power glance sensor that can detect or activate on a face of the user, or hands detected approaching the device.

At 306, a determination is made that the wireless device is in a stationary position based on the sensor inputs from the device sensors. For example, the input control module 130 implemented by the wireless device 102 can detect or determine that the wireless device 102 is in a stationary position 134 based on sensor inputs from the device sensors 136. For example, the device sensors 136 of the wireless device may include any one or combination of motion sensors, an accelerometer, a gyroscope, and/or any other type of sensors, such as may be implemented in an inertial measurement unit. The device sensors 136 can generate sensor data that indicates location, position, acceleration, rotational speed, and/or orientation of the device, and the input control module 130 can determine that the wireless device is in a stationary position 134, such as when set on a flat surface and/or is not being handled by a user of the device.

At 308, a touch input is received on a selectable element of the user interface. For example, the input control module 130 implemented by the wireless device 102 can receive a touch input 138 on a selectable element 116 of the user interface 114, which may be an inadvertent touch contact on the selectable element, rather than an intended user input that is received on the user interface 114 as a press, hold, tap, touch, or similar type input. In implementations, the touch inputs 138 are registered with the input control module 130. However, an inadvertent touch selection of a selectable element 116 is also registered as a touch input 138, but the user of the wireless device 102 may not have intended to initiate the corresponding device application action 118.

The input control module 130 can receive a touch input 138 (or an inadvertent touch contact) on a selectable element 120 of the user interface 114 within the region 124 of a curved display edge 110 of the display screen 108. Similarly, the input control module 130 can receive a touch input 138 (or an inadvertent touch contact) on any of the various selectable elements 122 of the user interface 114 within the regions 126, 128 of the display screen. As is common when a user of the wireless device 102 grabs or picks-up and moves the device, the input control module 130 may receive an inadvertent touch contact as a touch input 138 on a selectable element 122 of the user interface 114 within a corner region 140 of the display screen. These inadvertent activations may be caused by the hand, fingers, or palm coverage from a user of the device, such as when the device is moved as the user grabs the device to pick it up for use.

At 310, processing of the touch input on the selectable element of the user interface is delayed before determining whether the wireless device has been moved from the stationary position. For example, the input control module 130 implemented by the wireless device 102 can delay the processing of a touch input 138 on the selectable element 116 of the user interface 114 to determine whether the wireless device 102 has been moved from the stationary position 134 substantially incident, or in conjunction with, the touch input being received. In implementations, a touch input 138 on a selectable element 116 of the user interface 114 can be buffered for a short duration of time (e.g., 500 milliseconds) to allow for movement detection of the device before the touch input is processed for activation of the corresponding device application action 118.

At 312, a determination is made as to whether the wireless device has moved from the stationary position substantially incident to receiving the touch input. For example, the input control module 130 implemented by the wireless device 102 can detect or determine device movement 142 from the stationary position 134 substantially incident to the touch input 138 being received, such as based on accelerometer and/or gyroscopic inputs received from the device sensors 136, which indicate movement of the wireless device 102, such as from the stationary position 134 to a handheld position. Further, the input control module 130 can associate a touch input 138 within the corner region 140 of the display screen 108 with the likelihood of the wireless device 102 being handled by the user, and the touch input 138 is therefore likely an inadvertent touch contact on a selectable element 122 in the display region 128. The input control module 130 may also associate the imager input 144 with the detected movement 142 of the wireless device 102 from the stationary position 134 substantially incident to the touch input 138 being received. The input control module 130 can then determine a likelihood of the wireless device 102 being handled by the user and the touch input 138 is therefore likely an inadvertent touch contact on a selectable element.

If the wireless device has moved from the stationary position substantially incident to receiving the touch input (i.e., “Yes” from 312), then at 314, the touch input is disregarded if the wireless device is detected as having been moved from the stationary position substantially incident to receiving the touch input. For example, the input control module 130 implemented by the wireless device 102 can disregard the touch input 138 if the wireless device 102 is detected as having been moved from the stationary position 134 substantially incident to the touch input being received.

If the wireless device has not moved from the stationary position substantially incident to receiving the touch input (i.e., “No” from 312), then at 316, the touch input is processed if the wireless device is detected as not having been moved from the stationary position substantially incident to receiving the touch input. For example, the input control module 130 implemented by the wireless device 102 can allow or initiate processing the touch input 138 if the wireless device 102 is detected as not having been moved from the stationary position 134 substantially incident to the touch input being received.

FIG. 4 illustrates example method(s) 400 of managing touch inputs based on device movement, and is generally described with reference to a wireless device, as well as an input control module implemented by the device. The order in which the method is described is not intended to be construed as a limitation, and any number or combination of the described method operations can be performed in any order to perform a method, or an alternate method.

At 402, a user interface is displayed on a display screen with curved display edges of a wireless device, the user interface including one or more selectable elements that are selectable to initiate respective device application actions. For example, the display screen 108 of the wireless device 102 includes the curved display edges 110 on both vertical sides of the device, and the user interface 114 displays with selectable elements 116, such as the selectable elements 120, 122 that are user selectable to initiate corresponding device application actions 118 that are associated with respective device applications 112.

At 404, a determination is made that the wireless device is in a stationary position based on sensor inputs from device sensors. For example, the input control module 130 implemented by the wireless device 102 can detect or determine that the wireless device 102 is in a stationary position 134 based on sensor inputs from the device sensors 136. For example, the device sensors 136 of the wireless device may include any one or combination of motion sensors, an accelerometer, a gyroscope, and/or any other type of sensors, such as may be implemented in an inertial measurement unit. The device sensors 136 can generate sensor data that indicates location, position, acceleration, rotational speed, and/or orientation of the device, and the input control module 130 can determine that the wireless device is in a stationary position 134, such as when set on a flat surface and/or is not being handled by a user of the device.

At 406, a touch input on a selectable element of the user interface is received within a region of a curved display edge of the display screen. For example, the input control module 130 implemented by the wireless device 102 can receive a touch input 138 on a selectable element 116 of the user interface 114, which may be an inadvertent touch contact on the selectable element, rather than an intended user input that is received on the user interface 114 as a press, hold, tap, touch, or similar type input. In implementations, the touch inputs 138 are registered with the input control module 130. However, an inadvertent touch selection of a selectable element 116 is also registered as a touch input 138, but the user of the wireless device 102 may not have intended to initiate the corresponding device application action 118.

The input control module 130 can receive a touch input 138 (or an inadvertent touch contact) on a selectable element 120 of the user interface 114 within the region 124 of a curved display edge 110 of the display screen 108. Similarly, the input control module 130 can receive a touch input 138 (or an inadvertent touch contact) on any of the various selectable elements 122 of the user interface 114 within the regions 126, 128 of the display screen. As is common when a user of the wireless device 102 grabs or picks-up and moves the device, the input control module 130 may receive an inadvertent touch contact as a touch input 138 on a selectable element 122 of the user interface 114 within a corner region 140 of the display screen. These inadvertent activations may be caused by the hand, fingers, or palm coverage from a user of the device, such as when the device is moved as the user grabs the device to pick it up for use.

At 408, processing of the touch input on the selectable element of the user interface is delayed before determining whether the wireless device has been moved from the stationary position. For example, the input control module 130 implemented by the wireless device 102 can delay the processing of a touch input 138 on the selectable element 116 of the user interface 114 to determine whether the wireless device 102 has been moved from the stationary position 134 substantially incident, or in conjunction with, the touch input being received. In implementations, a touch input 138 on a selectable element 116 of the user interface 114 can be buffered for a short duration of time (e.g., 500 milliseconds) to allow for movement detection of the device before the touch input is processed for activation of the corresponding device application action 118.

At 410, detect whether the wireless device has been moved approximately simultaneously with the receiving the touch input. For example, the input control module 130 implemented by the wireless device 102 can detect or determine device movement 142 from the stationary position 134 substantially incident to the touch input 138 being received, such as based on accelerometer and/or gyroscopic inputs received from the device sensors 136, which indicate movement of the wireless device 102, such as from the stationary position 134 to a handheld position. Further, the input control module 130 can associate a touch input 138 within the corner region 140 of the display screen 108 with the likelihood of the wireless device 102 being handled by the user, and the touch input 138 is therefore likely an inadvertent touch contact on a selectable element 122 in the display region 128. The input control module 130 may also associate the imager input 144 with the detected movement 142 of the wireless device 102 from the stationary position 134 substantially incident to the touch input 138 being received. The input control module 130 can then determine a likelihood of the wireless device 102 being handled by the user and the touch input 138 is therefore likely an inadvertent touch contact on a selectable element.

At 412, the touch input is disregarded if the wireless device is detected as having been moved approximately simultaneously with receiving the touch input. For example, the input control module 130 implemented by the wireless device 102 can disregard the touch input 138 if the wireless device 102 is detected as having been moved from the stationary position 134 substantially incident to the touch input being received. The touch input 138 may be disregarded based on associating the imager input 144 with detecting that the wireless device 102 has been moved from the stationary position 134 approximately simultaneously with receiving the touch input.

At 414, the touch input is processed if the wireless device is detected as not having been moved approximately simultaneously with receiving the touch input. For example, the input control module 130 implemented by the wireless device 102 can allow or initiate processing the touch input 138 if the wireless device 102 is detected as not having been moved from the stationary position 134 substantially incident to the touch input being received.

FIG. 5 illustrates various components of an example device 500, which can implement aspects of the techniques and features for managing touch inputs based on device movement, as described herein. The example device 500 can be implemented as any of the devices described with reference to the previous FIGS. 1-4, such as any type of a wireless device, mobile device, mobile phone, flip phone, client device, companion device, paired device, display device, tablet, computing, communication, entertainment, gaming, media playback, and/or any other type of computing and/or electronic device. For example, the wireless device 102 described with reference to FIGS. 1-4 may be implemented as the example device 500.

The example device 500 can include various, different communication devices 502 that enable wired and/or wireless communication of device data 504 with other devices. The device data 504 can include any of the various devices data and content that is generated, processed, determined, received, stored, and/or transferred from one computing device to another, and/or synched between multiple computing devices. Generally, the device data 504 can include any form of audio, video, image, graphics, and/or electronic data that is generated by applications executing on a device. The communication devices 502 can also include transceivers for cellular phone communication and/or for any type of network data communication.

The example device 500 can also include various, different types of data input/output (I/O) interfaces 506, such as data network interfaces that provide connection and/or communication links between the devices, data networks, and other devices. The I/O interfaces 506 can be used to couple the device to any type of components, peripherals, and/or accessory devices, such as a computer input device that may be integrated with the example device 500. The I/O interfaces 506 may also include data input ports via which any type of data, information, media content, communications, messages, and/or inputs can be received, such as user inputs to the device, as well as any type of audio, video, image, graphics, and/or electronic data received from any content and/or data source.

The example device 500 includes a processor system 508 of one or more processors (e.g., any of microprocessors, controllers, and the like) and/or a processor and memory system implemented as a system-on-chip (SoC) that processes computer-executable instructions. The processor system may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that may be implemented in connection with processing and control circuits, which are generally identified at 510. The example device 500 may also include any type of a system bus or other data and command transfer system that couples the various components within the device. A system bus can include any one or combination of different bus structures and architectures, as well as control and data lines.

The example device 500 also includes memory and/or memory devices 512 (e.g., computer-readable storage memory) that enable data storage, such as data storage devices implemented in hardware that can be accessed by a computing device, and that provide persistent storage of data and executable instructions (e.g., software applications, programs, functions, and the like). Examples of the memory devices 512 include volatile memory and non-volatile memory, fixed and removable media devices, and any suitable memory device or electronic data storage that maintains data for computing device access. The memory devices 512 can include various implementations of random-access memory (RAM), read-only memory (ROM), flash memory, and other types of storage media in various memory device configurations. The example device 500 may also include a mass storage media device.

The memory devices 512 (e.g., as computer-readable storage memory) provide data storage mechanisms, such as to store the device data 504, other types of information and/or electronic data, and various device applications 514 (e.g., software applications and/or modules). For example, an operating system 516 can be maintained as software instructions with a memory device and executed by the processor system 508 as a software application. The device applications 514 may also include a device manager, such as any form of a control application, software application, signal-processing and control module, code that is specific to a particular device, a hardware abstraction layer for a particular device, and so on.

In this example, the device 500 includes an input control module 518 and a grip detection module 520 that implement various aspects of the described features and techniques for managing touch inputs based on device movement. The modules may each be implemented with hardware components and/or in software as one of the device applications 514, such as when the example device 500 is implemented as the wireless device 102 described with reference to FIGS. 1-4. An example of the input control module 518 includes the input control module 130, and an example of the grip detection module 520 includes the grip detection module 132 that is implemented by the wireless device 102, such as software applications and/or as hardware components in the wireless device. In implementations, the input control module 518 and the grip detection module 520 may include independent processing, memory, and logic components as a computing and/or electronic device integrated with the example device 500.

The example device 500 can also include cameras 522 and/or motion sensors 524, such as may be implemented as components of an inertial measurement unit (IMU). The motion sensors 524 can be implemented with various sensors, such as a gyroscope, an accelerometer, and/or other types of motion sensors to sense motion of the device. The motion sensors 524 can generate sensor data vectors having three-dimensional parameters (e.g., rotational vectors in x, y, and z-axis coordinates) indicating location, position, acceleration, rotational speed, and/or orientation of the device. The example device 500 can also include one or more power sources 526, such as when the device is implemented as a wireless device and/or mobile device. The power sources may include a charging and/or power system, and can be implemented as a flexible strip battery, a rechargeable battery, a charged super-capacitor, and/or any other type of active or passive power source.

The example device 500 can also include an audio and/or video processing system 528 that generates audio data for an audio system 530 and/or generates display data for a display system 532. The audio system and/or the display system may include any types of devices that generate, process, display, and/or otherwise render audio, video, display, and/or image data. Display data and audio signals can be communicated to an audio component and/or to a display component via any type of audio and/or video connection or data link. In implementations, the audio system and/or the display system are integrated components of the example device 500. Alternatively, the audio system and/or the display system are external, peripheral components to the example device.

Although implementations of managing touch inputs based on device movement have been described in language specific to features and/or methods, the appended claims are not necessarily limited to the specific features or methods described. Rather, the specific features and methods are disclosed as example implementations of managing touch inputs based on device movement, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

A wireless device, comprising: a display screen to display a user interface including one or more selectable elements that are selectable to initiate respective device application actions; an input control module implemented at least partially in hardware and configured to: determine that the wireless device is in a stationary position based on sensor inputs from device sensors; receive a touch input on a selectable element of the user interface; detect whether the wireless device has been moved from the stationary position substantially incident to the touch input being received; and disregard the touch input if the wireless device is detected as having been moved from the stationary position substantially incident to the touch input being received.

Alternatively or in addition to the above described wireless device, any one or combination of: the input control module is configured to initiate processing the touch input if the wireless device is detected as not having been moved from the stationary position substantially incident to the touch input being received. The input control module is configured to: receive at least one of accelerometer or gyroscope inputs indicating movement of the wireless device from the stationary position to a handheld position; and detect whether the wireless device has been moved from the stationary position substantially incident to the touch input being received based on the at least one accelerometer or gyroscope inputs. The display screen includes curved display edges to display a portion of the user interface; and the input control module is configured to receive the touch input on the selectable element of the user interface within a region of a curved display edge of the display screen. The input control module is configured to: receive the touch input on the selectable element of the user interface within a corner region of the display screen; and associate the touch input within the corner region of the display screen with a likelihood of the wireless device being handled and the touch input being an inadvertent selection of the selectable element. The input control module is configured to: receive an imager input from an imaging sensor, the imager input including an image of a user approaching the wireless device; and associate the imager input with the detection that the wireless device has been moved from the stationary position substantially incident to the touch input being received. The input control module is configured to delay processing the touch input on the selectable element of the user interface to determine whether the wireless device has been moved from the stationary position.

A method, comprising: displaying a user interface on a display screen of a wireless device, the user interface including one or more selectable elements that are selectable to initiate respective device application actions; determining that the wireless device is in a stationary position based on sensor inputs from device sensors; receiving a touch input on a selectable element of the user interface; detecting whether the wireless device has been moved from the stationary position substantially incident to receiving the touch input; and disregarding the touch input if the wireless device is detected as having been moved from the stationary position substantially incident to receiving the touch input.

Alternatively or in addition to the above described method, any one or combination of: processing the touch input if the wireless device is detected as not having been moved from the stationary position substantially incident to receiving the touch input. The method further comprising: receiving at least one of accelerometer or gyroscope inputs indicating movement of the wireless device from the stationary position to a handheld position; and wherein the detecting whether the wireless device has been moved from the stationary position substantially incident to receiving the touch input based on the at least one accelerometer or gyroscope inputs. The display screen includes curved display edges to display a portion of the user interface; and the receiving the touch input on the selectable element of the user interface is within a region of a curved display edge of the display screen. The receiving the touch input on the selectable element of the user interface is within a corner region of the display screen; and the method further comprising associating the touch input within the corner region of the display screen with a likelihood of the wireless device being handled and the touch input being an inadvertent selection of the selectable element. The method further comprising: receiving an imager input from an imaging sensor, the imager input including an image of a user approaching the wireless device; and associating the imager input with the detecting that the wireless device has been moved from the stationary position substantially incident to the touch input being received. The method further comprising delaying processing of the touch input on the selectable element of the user interface before determining whether the wireless device has been moved from the stationary position.

A method, comprising: displaying a user interface on a display screen with curved display edges of a wireless device, the user interface including one or more selectable elements that are selectable to initiate respective device application actions; receiving the touch input on a selectable element of the user interface within a region of a curved display edge of the display screen; detecting whether the wireless device has been moved approximately simultaneously with the receiving the touch input; and disregarding the touch input if the wireless device is detected as having been moved approximately simultaneously with receiving the touch input.

Alternatively or in addition to the above described method, any one or combination of: processing the touch input if the wireless device is detected as not having been moved approximately simultaneously with receiving the touch input. The method further comprising: receiving sensor inputs from device sensors; determining that the wireless device is in a stationary position based on the sensor inputs from the device sensors; and delaying processing of the touch input on the selectable element of the user interface before determining whether the wireless device has been moved from the stationary position. The detecting whether the wireless device has been moved includes the determining whether the wireless device has been moved from the stationary position substantially incident to receiving the touch input. The method further comprising: receiving an imager input from an imaging sensor, the imager input including an image of a user approaching the wireless device; and associating the imager input with the detecting that the wireless device has been moved from the stationary position approximately simultaneously with the receiving the touch input. The receiving the touch input on the selectable element of the user interface is within a corner region of the display screen; and the method further comprising associating the touch input within the corner region of the display screen with a likelihood of the wireless device being handled and the touch input being an inadvertent selection of the selectable element.

1. A wireless device, comprising:
a display screen to display a user interface including one or more selectable elements that are selectable to initiate respective device application actions;
an input control module implemented at least partially in hardware and configured to:
determine that the wireless device is in a stationary position based on sensor inputs from device sensors;
receive a touch input on a selectable element of the user interface;
detect whether the wireless device has been moved from the stationary position substantially incident to the touch input being received; and
disregard the touch input if the wireless device is detected as having been moved from the stationary position substantially incident to the touch input being received.

2. The wireless device as recited in claim 1, wherein the input control module is configured to initiate processing the touch input if the wireless device is detected as not having been moved from the stationary position substantially incident to the touch input being received.

3. The wireless device as recited in claim 1, wherein the input control module is configured to:
receive at least one of accelerometer or gyroscope inputs indicating movement of the wireless device from the stationary position to a handheld position; and
detect whether the wireless device has been moved from the stationary position substantially incident to the touch input being received based on the at least one accelerometer or gyroscope inputs.

4. The wireless device as recited in claim 1, wherein:
the display screen includes curved display edges to display a portion of the user interface; and
the input control module is configured to receive the touch input on the selectable element of the user interface within a region of a curved display edge of the display screen.

5. The wireless device as recited in claim 1, wherein the input control module is configured to:
receive the touch input on the selectable element of the user interface within a corner region of the display screen; and
associate the touch input within the corner region of the display screen with a likelihood of the wireless device being handled and the touch input being an inadvertent selection of the selectable element.

6. The wireless device as recited in claim 1, wherein the input control module is configured to:
receive an imager input from an imaging sensor, the imager input including an image of a user approaching the wireless device; and
associate the imager input with the detection that the wireless device has been moved from the stationary position substantially incident to the touch input being received.

7. The wireless device as recited in claim 1, wherein the input control module is configured to delay processing the touch input on the selectable element of the user interface to determine whether the wireless device has been moved from the stationary position.

8. A method, comprising:
displaying a user interface on a display screen of a wireless device, the user interface including one or more selectable elements that are selectable to initiate respective device application actions;
determining that the wireless device is in a stationary position based on sensor inputs from device sensors;
receiving a touch input on a selectable element of the user interface;
detecting whether the wireless device has been moved from the stationary position substantially incident to receiving the touch input; and
disregarding the touch input if the wireless device is detected as having been moved from the stationary position substantially incident to receiving the touch input.

9. The method as recited in claim 8, further comprising processing the touch input if the wireless device is detected as not having been moved from the stationary position substantially incident to receiving the touch input.

10. The method as recited in claim 8, further comprising:
receiving at least one of accelerometer or gyroscope inputs indicating movement of the wireless device from the stationary position to a handheld position; and wherein
the detecting whether the wireless device has been moved from the stationary position substantially incident to receiving the touch input based on the at least one accelerometer or gyroscope inputs.

11. The method as recited in claim 8, wherein:
the display screen includes curved display edges to display a portion of the user interface; and
the receiving the touch input on the selectable element of the user interface is within a region of a curved display edge of the display screen.

12. The method as recited in claim 8, wherein:
the receiving the touch input on the selectable element of the user interface is within a corner region of the display screen; and
the method further comprising associating the touch input within the corner region of the display screen with a likelihood of the wireless device being handled and the touch input being an inadvertent selection of the selectable element.

13. The method as recited in claim 8, further comprising:
receiving an imager input from an imaging sensor, the imager input including an image of a user approaching the wireless device; and
associating the imager input with the detecting that the wireless device has been moved from the stationary position substantially incident to the touch input being received.

14. The method as recited in claim 8, further comprising delaying processing of the touch input on the selectable element of the user interface before determining whether the wireless device has been moved from the stationary position.

15. A method, comprising:
displaying a user interface on a display screen with curved display edges of a wireless device, the user interface including one or more selectable elements that are selectable to initiate respective device application actions;
receiving the touch input on a selectable element of the user interface within a region of a curved display edge of the display screen;
detecting whether the wireless device has been moved approximately simultaneously with the receiving the touch input; and
disregarding the touch input if the wireless device is detected as having been moved approximately simultaneously with receiving the touch input.

16. The method as recited in claim 15, further comprising processing the touch input if the wireless device is detected as not having been moved approximately simultaneously with receiving the touch input.

17. The method as recited in claim 15, further comprising:
receiving sensor inputs from device sensors;
determining that the wireless device is in a stationary position based on the sensor inputs from the device sensors; and
delaying processing of the touch input on the selectable element of the user interface before determining whether the wireless device has been moved from the stationary position.

18. The method as recited in claim 17, wherein the detecting whether the wireless device has been moved includes the determining whether the wireless device has been moved from the stationary position substantially incident to receiving the touch input.

19. The method as recited in claim 17, further comprising:
receiving an imager input from an imaging sensor, the imager input including an image of a user approaching the wireless device; and
associating the imager input with the detecting that the wireless device has been moved from the stationary position approximately simultaneously with the receiving the touch input.

20. The method as recited in claim 15, wherein:
the receiving the touch input on the selectable element of the user interface is within a corner region of the display screen; and
the method further comprising associating the touch input within the corner region of the display screen with a likelihood of the wireless device being handled and the touch input being an inadvertent selection of the selectable element.
